(19) United States
(12) Patent Application Publication
(10) Pub. No.: US 2017/0351301 A1
(43) Pub. Date: Dec. 7, 2017

(54) CASING OF CARD CONNECTOR HAVING SHELL WITH SLIDE HOLE AND ELECTRONIC APPARATUS INCLUDING CARD CONNECTOR

(71) Applicant: FUJITSU LIMITED, Kawasaki-shi (JP)

(72) Inventor: Koki Takahashi, Kawasaki (JP)

(73) Assignee: FUJITSU LIMITED, Kawasaki-shi (JP)

(21) Appl. No.: 15/439,983

(22) Filed: Feb. 23, 2017

(30) Foreign Application Priority Data
Jun. 6, 2016 (JP) 2016-112418

(51) Int. Cl. G06F 1/16; H01R 12/71; H01R 13/635; H01R 13/639

(52) U.S. Cl. CPC G06F 1/1658; H01R 13/639; H01R 12/71; H01R 13/635

(57) ABSTRACT

A card connector includes: a casing including a shell having a slide hole and a slit into which a card is inserted; an ejector, provided in the casing, configured to move together with the card that is inserted into the casing; a rotating member, supported by the ejector, configured to rotate when the ejector moves; and a projection that is provided at a first end of the rotating member opposite to a second end of the rotating member with respect to an axis of a rotation of the rotating member, comes into contact with the card and slides along the slide hole when the ejector moves.

### CROSS-REFERENCE TO RELATED APPLICATION

This application is based upon and claims the benefit of priority of the prior Japanese Patent Application No. 2016-112418, filed on Jun. 6, 2016, the entire contents of which are incorporated herein by reference.

### FIELD

The embodiment discussed herein is related to a card connector and an electronic apparatus.

### BACKGROUND

Electronic apparatuses, such as personal computers and smart phones, include card connectors so that memory cards and the like (hereinafter simply referred to as “cards”) are attachable thereto.

A related technique is disclosed by Japanese Laid-open Patent Publication No. 2013-206766.

### SUMMARY

According to an aspect of the embodiments, a card connector includes: a casing including a shell having a slide hole and a slit into which a card is inserted; an ejector, provided in the casing, configured to move together with the card that is inserted into the casing; a rotating member, supported by the ejector, configured to rotate when the ejector moves; and a projection that is provided at a first end of the rotating member opposite to a second end of the rotating member with respect to an axis of a rotation of the rotating member, comes into contact with the card and slides along the slide hole when the ejector moves.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary electronic apparatus;

FIG. 2 is a plan view of an exemplary card connector;

FIG. 3 is an internal plan view of the exemplary card connector;

FIG. 4 is an exemplary plan view of an ejector;

FIG. 5 is an exemplary perspective view of the ejector with a rotating member attached thereto;

FIG. 6 illustrates an exemplary section of a part of the ejector that is taken along line VI-VI illustrated in FIG. 5;

FIGS. 7A to 7D are transparent diagrams illustrating exemplary behaviors of the card connector;

FIG. 8 illustrates an exemplary movement of a projection; and

FIG. 9 illustrates an exemplary shape of a slide hole.

### DESCRIPTION OF EMBODIMENT

An exemplary card connector includes a locking mechanism. When a card is inserted into a slit of the card connector and is pushed into the card connector, the locking mechanism operates to lock the card in the card connector. Hence, accidental disconnection of the card from the card connector due to vibrations or the like is avoided.

In the state where a card is locked in the card connector, the card and an electronic apparatus are electrically connected to each other. Thus, data is allowed to be written on and read from the card. In the state where a card is locked in the card connector, an end of the card slightly projects from the card connector.

To unlock the card, the end of the card is pushed into the card connector. Thus, the card is unlocked, and an end portion of the card is ejected from the slit of the card connector by the urging force of a spring. The user pinches the ejected end portion of the card with fingers and pulls out the card. Thus, the card is removed from the card connector.

In an exemplary case of a card connector for small cards, the length by which the card is ejected from the card connector (the length of ejection) when the card is unlocked is as short as about 3 mm, and it is therefore difficult to pinch the card with fingers. There is another exemplary proposed card connector in which the length of ejection of the card is increased by utilizing a rotating member that is urged by a spring.

Since the above card connector includes the spring that urges the rotating member, the number of components increases correspondingly, which may make the work of assembling the card connector complicated.

For example, there may be provided a card connector formed of a small number of components and in which the length of ejection of the card is large, and an electronic apparatus including such a card connector.

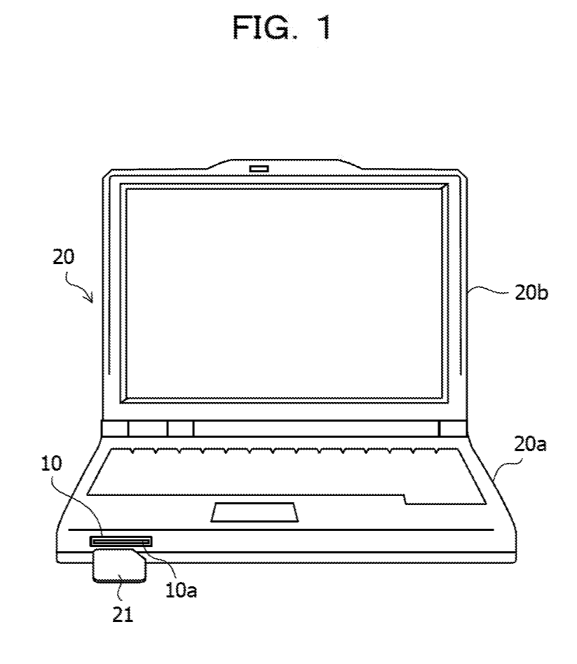

FIG. 1 illustrates an exemplary electronic apparatus, which may be a laptop personal computer.

An electronic apparatus 20 illustrated in FIG. 1 includes a body-side casing 20a provided with a keyboard and so forth, and a panel-side casing 20b provided with a display panel and so forth. The body-side casing 20a and the panel-side casing 20b are connected to each other with an openable-and-closable mechanism (a hinge).

The body-side casing 20a includes a card connector 10. The card connector 10 has a slit 10a into which a card 21 is to be inserted. The card 21 has a substantially rectangular shape with a corner on one of the short sides thereof obliquely cut off. When the card 21 is inserted into the slit 10a from the short side thereof having the cut corner (the short-side end of the card 21 is hereinafter referred to as “the head” of the card 21), a locking mechanism operates to lock the card 21.

In the state where the card 21 is locked, an electrode of the card 21 is in contact with an electrode provided in the card connector 10, allowing data to be written on and read from the card 21.

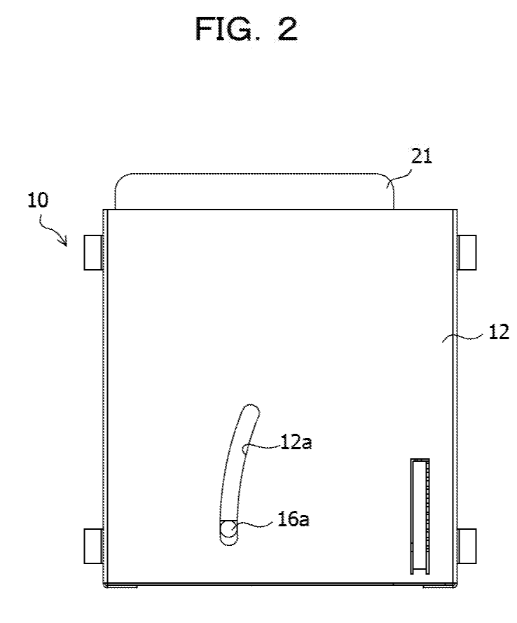

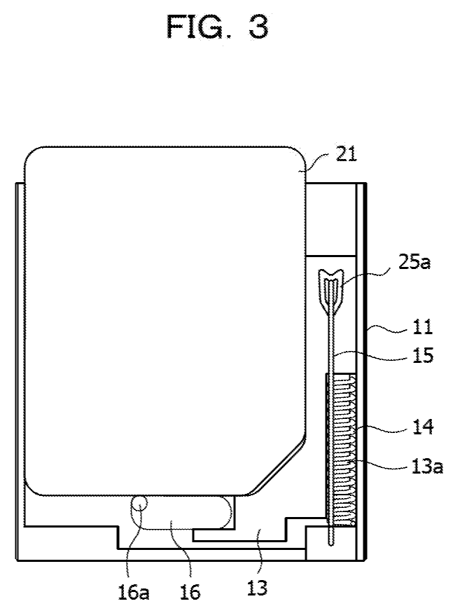

FIG. 2 is a plan view of an exemplary card connector. FIG. 3 is an internal plan view of the exemplary card connector. The card connector illustrated in FIGS. 2 and 3 may be the card connector 10 illustrated in FIG. 1.

The card connector 10 has a casing that is a combination of a housing 11 and a shell 12. As illustrated in FIG. 3, the card connector 10 includes an ejector 13, a coil spring 14, a pin 15, a rotating member 16, and so forth. The electrode may also be provided in the card connector 10.

The housing 11 has recesses that receive the card 21, the ejector 13, the coil spring 14, the pin 15, the rotating member 16, and so forth. The shell 12 is a flat member and is provided over the housing 11. The shell 12 has a slide hole 12a that curves in a predetermined direction (the slide hole 12a has a substantially arc shape). When the card 21 is inserted into the card connector 10 and when the card 21 is ejected from the card connector 10, a projection 16a provided on the rotating member 16 slides along the slide hole 12a while being in contact with the head of the card 21.

Hereinafter, as a matter of convenience of description, a side of the card connector 10 on which the slit 10a for inserting the card 21 is provided (the upper side in FIGS. 2 and 3) is defined as the upper side, and the opposite side of the card connector 10 is defined as the lower side.

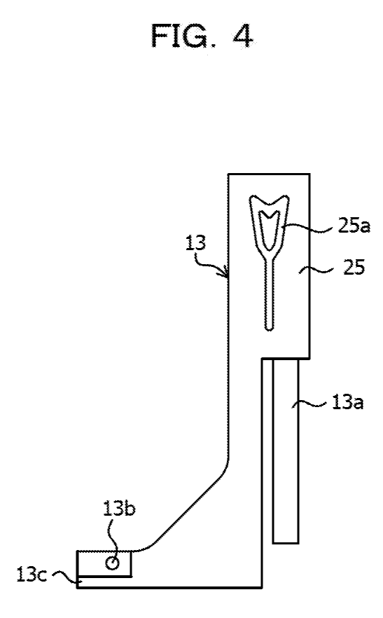

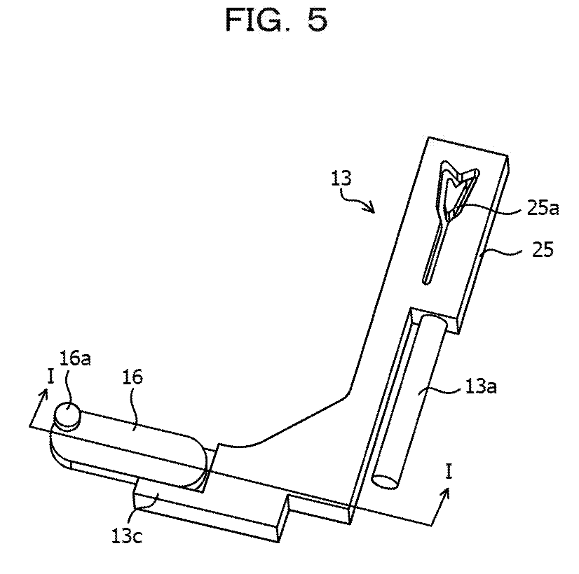

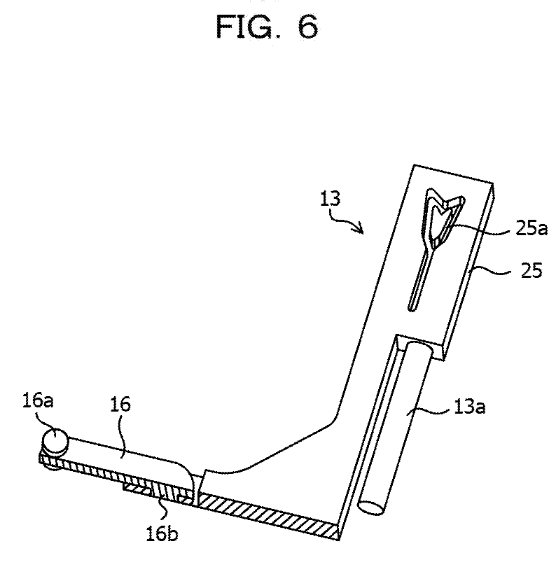

FIG. 4 is an exemplary plan view of the ejector 13. FIG. 5 is an exemplary perspective view of the ejector 13 with the rotating member 16 attached thereto. FIG. 6 illustrates an exemplary section of a part of the ejector 13 that is taken along line VI-VI illustrated in FIG. 5.

As illustrated in FIG. 4, the ejector 13 has a substantially L shape conforming to the outline of a part, at and near the cut corner, of the card 21. The ejector 13 is movable in the top-bottom direction in the card connector 10 along with the card 21.

The ejector 13 includes a heart cam portion 25 having a heart-shaped groove (hereinafter denoted as “heart cam groove 25a”) at an upper-end portion thereof. The ejector 13 includes a supporting bar 13a extending downward from the heart cam portion 25.

The coil spring 14 is wound around the supporting bar 13a such that the center axis thereof coincides with the center axis of the supporting bar 13a. The lower end of the coil spring 14 is fixed to the housing 11. The ejector 13 is urged by the coil spring 14 upward, specifically, in a direction opposite to the direction of insertion of the card 21. The coil spring 14 may be an exemplary urging member.

The pin 15 is one of elements that constitute the locking mechanism, and so is the heart cam groove 25a. Two ends of the pin 15 are bent. The lower end of the pin 15 is fixed to the housing 11. The upper end (hereinafter referred to as “the head”) of the pin 15 is positioned in the heart cam groove 25a.

The heart cam groove 25a has a bottom surface that is not flat but is inclined at angles varying with positions in a predetermined manner. Hence, as the ejector 13 moves, the head of the pin 15 moves along the heart cam groove 25a in a specific direction, for example, in the counterclockwise direction.

As illustrated in FIGS. 4 and 6, the ejector 13 has, in a lower-end portion thereof, a hole 13b that receives a rotational shaft 16b of the rotating member 16. The rotating member 16 has the projection 16a at an end thereof opposite an end thereof having the rotational shaft 16b. The projection 16a is fitted in the slide hole 12a provided in the shell 12. The ejector 13 includes a stopper 13c at the lower end thereof. The stopper 13c limits the range of rotation of the rotating member 16.

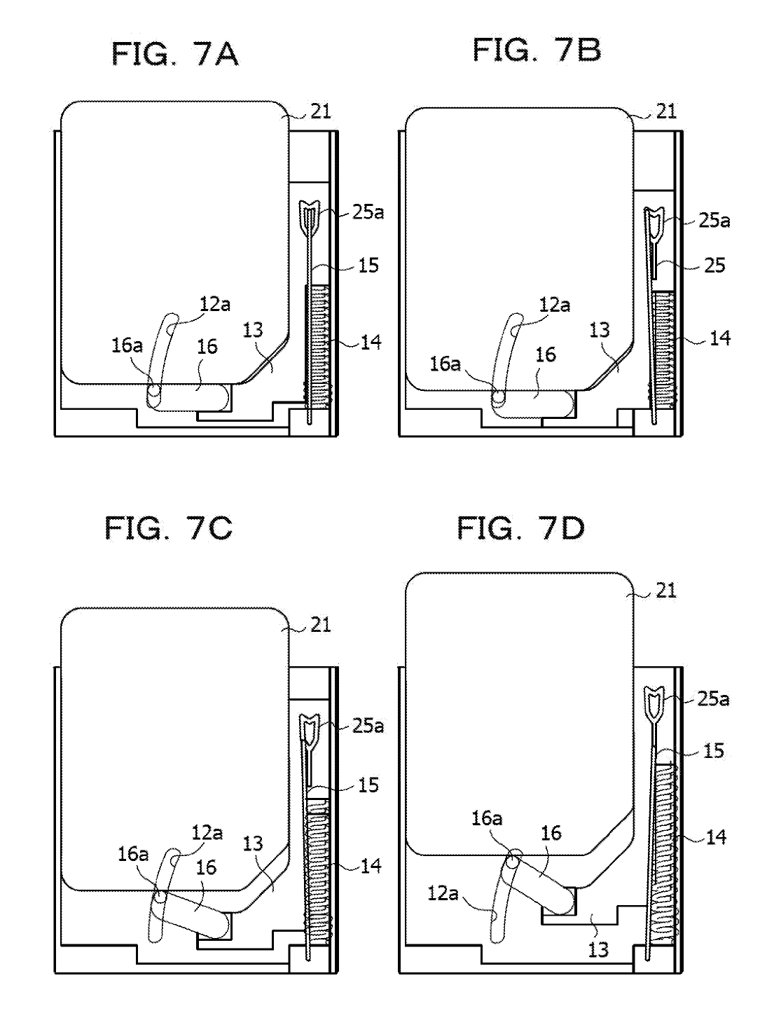

FIGS. 7A to 7D are transparent diagrams illustrating exemplary behaviors of the card connector 10.

FIG. 7A illustrates a state where the card 21 inserted into the card connector 10 is locked.

To attach the card 21 to the card connector 10, the head of the card 21 is first inserted into the slit 10a (see FIG. 1) of the card connector 10, and the tail of the card 21 is pushed with a finger. Thus, the card 21 advances into the card connector 10, and the head of the card 21 comes into contact with the ejector 13. As the card 21 advances, the ejector 13 moves downward.

Then, with the downward movement of the ejector 13, the coil spring 14 is compressed, and the head of the pin 15 moves along the heart cam groove 25a from the lower end of the heart cam groove 25a and in the counterclockwise direction. When the card 21 is fully pushed into the card connector 10 and the finger is then removed from the card 21, the head of the pin 15 is positioned at the top center of the heart cam groove 25a as illustrated in FIG. 7A. Thus, the ejector 13 is fixed while being urged upward by the coil spring 14, and the card 21 is locked (this state is hereinafter referred to as the locked state).

In the locked state, as illustrated in FIG. 7A, the rotating member 16 is oriented substantially horizontally, and the projection 16a is positioned near the lower end of the slide hole 12a. In the locked state, the electrode of the card 21 and the electrode of the card connector 10 are in contact with each other. Hence, data is allowed to be written on and read from the card 21.

To unlock the card 21, the tail of the card 21 is pushed into the card connector 10 with a finger. Thus, as illustrated in FIG. 7B, the head of the pin 15 moves to the left from the top center of the heart cam groove 25a. Then, when the finger is removed from the card 21, the ejector 13 starts to move upward while being pushed by the coil spring 14.

FIG. 7C illustrates a state where the ejector 13 is moving upward. When the card 21 is unlocked as described above, the ejector 13 starts to move upward with the urging force exerted by the coil spring 14. In this step, the head of the pin 15 moves along the left part of the heart cam groove 25a toward the lower side of the heart cam groove 25a.

With the upward movement of the ejector 13, the projection 16a of the rotating member 16 moves (slides) upward along the slide hole 12a. Hence, the card 21 is pushed upward by the projection 16a, whereby a gap is produced between the head of the card 21 and the lower-end portion of the ejector 13.

FIG. 7D illustrates a state where the ejector 13 has reached the top end of the movable range thereof.

With the upward movement of the ejector 13, the projection 16a of the rotating member 16 moves upward along the slide hole 12a. Accordingly, the gap between the head of the card 21 and the lower-end portion of the ejector 13 is widened. When the ejector 13 reaches the top end of the movable range thereof, the head of the pin 15 reaches the lower end of the heart cam groove 25a, whereby further upward movement of the ejector 13 is suppressed.

For example, the ejector 13 moves in the card connector 10 by 3 mm, and the rotating member 16 moves the card 21 by 2 mm, whereby the card 21 is ejected from the card connector 10 by 5 mm.

In the case of the card connector 10 described above, when the ejector 13 moves, the projection 16a of the rotating member 16 moves along the slide hole 12a and pushes up the card 21. Hence, the length of ejection of the card 21 may be greater than in a case of a card connector in which the card moves together with the ejector.

In the case of the card connector 10, when the projection 16a slides along the slide hole 12a, the rotating member 16 rotates. Hence, a spring that urges the rotating member 16 does not have to be provided. Accordingly, the number of components is reduced. Consequently, the work of assembling the card connector 10 may become less complicated.

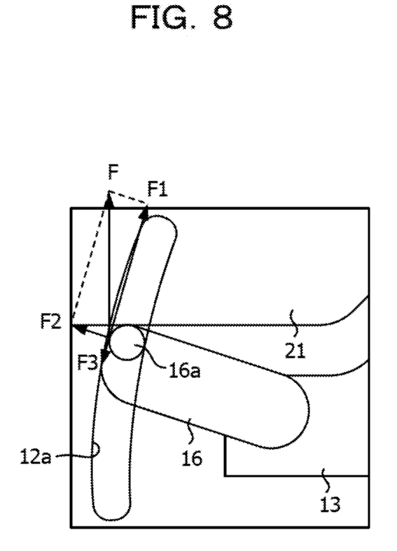

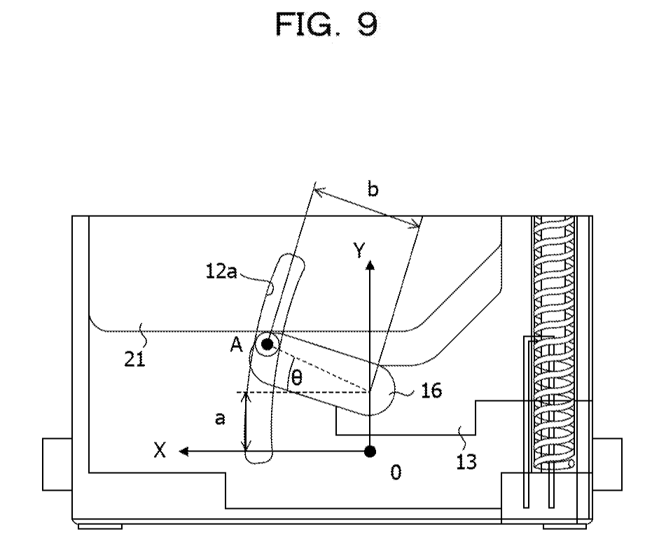

FIG. 8 illustrates an exemplary movement of the projection 16a. FIG. 9 illustrates an exemplary shape of the slide hole 12a. Referring to FIGS. 8 and 9, the movement of the projection 16a will now be described.

As described above, as the ejector 13 moves, the projection 16a slides along the slide hole 12a, whereby the rotating member 16 rotates.

For example, as illustrated in FIG. 8, a force applied to the rotating member 16 with the movement of the ejector 13 is denoted by F. The force F is composed of a component F₁ acting in a direction tangential to the slide hole 12a, and a component F₂ acting in a direction normal to the slide hole 12a. The component F₁ acting in the tangential direction may be a force that moves the projection 16a of the rotating member 16 along the slide hole 12a.

A frictional force F₃ is generated between the projection 16a and the slide hole 12a. The frictional force F₃ acts in a direction in which the movement of the projection 16a is suppressed.

The frictional force F₃ is expressed as F₃=μF₂ (where μ denotes the coefficient of friction). The coefficient of friction μ depends on factors such as the material of the rotating member 16 and the shape of the slide hole 12a.

If the component F₁ acting in the tangential direction is set to be greater than the frictional force F₃ (F₁>F₃), the movement of the ejector 13 moves the projection 16a along the slide hole 12a. In such a situation, the shape of the slide hole 12a determines the movement of the projection 16a.

The shape of the slide hole 12a may be determined in accordance with the locus of the center of the projection 16a that is represented by point A in FIG. 9.

For example, the point through which the axis of rotation of the rotating member 16 in the locked state passes is defined as the origin (O), the horizontal direction is defined by the X axis, and the top-bottom direction, that is, the direction in which the card 21 moves in the card connector 10, is defined by the Y axis.

The length by which the axis of rotation of the rotating member 16 is shifted from the origin O in the Y direction is denoted by a. The length from the axis of rotation of the rotating member 16 to the point A is denoted by b. The angle of a line connecting the axis of rotation of the rotating member 16 and the point A with respect to the X axis is denoted by θ. The length a and the angle θ are variable. The length b is constant.

Letting the X coordinate and the Y coordinate of the point A be Ax and Ay, respectively, if the length a and the angle θ are determined, the X coordinate and the Y coordinate of the point A are expressed as follows.

Ax=b cos θ (1)

Ay=a+b sin θ (2)

If the shape of the slide hole 12a is determined such that Equations (1) and (2) above are satisfied, the projection 16a smoothly moves along the slide hole 12a.

While the above embodiment concerns a case where the electronic apparatus 20 is a laptop personal computer, the electronic apparatus 20 may be another electronic apparatus: for example, a portable terminal apparatus such as a smart phone, a digital camera, or a printer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

1. A card connector comprising:
a casing including a shell having a slide hole and a slit into which a card is inserted;
an ejector, provided in the casing, configured to move together with the card that is inserted into the casing;
a rotating member, supported by the ejector, configured to rotate when the ejector moves; and
a projection that is provided at a first end of the rotating member opposite to a second end of the rotating member with respect to an axis of a rotation of the rotating member, comes into contact with the card and slides along the slide hole when the ejector moves.

2. The card connector according to claim 1, wherein the slide hole has an arc shape.

3. The card connector according to claim 1, further comprising:
a locking mechanism provided to the ejector and configured to lock the card in the casing.

4. The card connector according to claim 3, wherein, when a position of an axis of rotation of the rotating member in a state where the card is locked by the locking mechanism is defined as an origin; a direction in which the card moves in the housing is defined by a Y axis; and a direction orthogonal to the Y axis is defined by an X axis, the shape of the slide hole is determined such that the following equations are satisfied:
Ax=b cos θ
Ay=a+b sin θ
where Ax denotes an X coordinate of a center of the projection, Ay denotes a Y coordinate of the center of the projection, a denotes a length in the Y direction from the origin, b denotes a length from the axis of rotation of the rotating member to the center of the projection, and θ denotes an angle of a line coupling the axis of rotation of the rotating member and the center of the projection with respect to the X axis.

5. The card connector according to claim 2, wherein the ejector has an L shape.

6. An electronic apparatus comprising:
a body-side casing including a card connector; and
a panel-side casing including a display panel and coupled to the body-side casing,
the card connector includes:
a casing including a shell having a slide hole and a slit into which a card is inserted;
an ejector, provided in the casing, configured to move together with the card that is inserted into the casing;
a rotating member, supported by the ejector, configured to rotate when the ejector moves; and
a projection that is provided at a first end of the rotating member opposite to a second an end with respect to an axis of a rotation of the rotating member, comes into contact with the card and slides along the slide hole when the ejector moves.

7. The electronic apparatus according to claim 6, wherein the slide hole has an arc shape.

8. The electronic apparatus according to claim 6, wherein the card connector includes a locking mechanism provided to the ejector and configured to lock the card in the casing.

9. The electronic apparatus according to claim 6, wherein, when a position of an axis of rotation of the rotating member in a state where the card is locked by the locking mechanism is defined as an origin; a direction in which the card moves in the housing is defined by a Y axis; and a direction orthogonal to the Y axis is defined by an X axis, the shape of the slide hole is determined such that the following equations are satisfied:
Ax=b cos θ
Ay=a+b sin θ
where Ax denotes an X coordinate of a center of the projection, Ay denotes a Y coordinate of the center of the projection, a denotes a length in the Y direction from the origin, b denotes a length from the axis of rotation of the rotating member to the center of the projection, and θ denotes an angle of a line coupling the axis of rotation of the rotating member and the center of the projection with respect to the X axis.

10. The electronic apparatus according to claim 7, wherein the ejector has an L shape.
